(19) United States
(12) Patent Application Publication
(10) Pub. No.: US 2005/0242603 A1
(43) Pub. Date: Nov. 3, 2005

(54) Profile element for mounting on a support element

(76) Inventors: Volker Holderle, Backnang (DE); Hans Hermann Otte, Varel (DE)

Correspondence Address: Robin W. Asher;Clark Hill PLC, Suite 3500, 500 Woodward Avenue, Detroit, MI, 48226-3435, US

(21) Appl. No.: 11/120,882

(22) Filed: May 3, 2005

(30) Foreign Application Priority Data
May 3, 2004 (DE) 20 2004 007 014.6

(51) Int. Cl. B60R 13/04

(52) U.S. Cl. 296/1.08

(57) ABSTRACT

A profile element for mounting on a vehicle radiator grill. The profile element has a longitudinal extension with a latch provided on an inner side of the profile element. The latch is arranged on the region an edge of the longitudinal extension and adapted to latch to a complementary latch on the vehicle radiator grill. The latch includes a first portion which extends in a substantially cantilevered fashion away from the inner side and a second portion which extends substantially in a direction of the corresponding opposite edge of the longitudinal extension.

The invention relates to a profile element for mounting on a support element which is used particularly in a radiator grille on a vehicle.

In constructing a radiator grille for a vehicle it is known to use at least one elongate profile element or a plurality of such profile elements in the form of a decorative strip, and the profile element or elements may be mounted horizontally or vertically within the radiator grille. Usually, a plurality of such profile elements are part of a so-called chrome frame which is inserted as such in a suitable support element of the radiator grille.

In the construction of the radiator grille the profile element or chrome frame is mounted on the support element in a direction along the longitudinal axis of the vehicle and is permanently clipped or latched thereto. For this purpose the profile element has a snap-fit hook or the like on its inside which is formed in an edge region of the longitudinal extension and extends away from the inside. The snap-fit hook latches with engaging means of the support element formed to complement it.

The generally low height of the profile element means that there is no need to mount snap-fit hooks or the like on both the upper and lower edges of the profile element. The conventional profile elements of low height can easily be fixed to the support part by means of the snap-fit hook, which is provided only in one edge region of the longitudinal extension, without any separate snap-fit hooks or the like being provided on the opposite edge of the profile element.

The conventional profile elements described above do, however, have the disadvantage that the height of such elements having a snap-fit hook or the like provided only in one edge region is restricted to a certain dimension, in order to ensure precise and accurate fixing to the support element. If the height of the profile element is increased, when it is secured by means of a snap-fit hook provided in only one edge region, there is the problem of undesirable torsion of the profile element in its longitudinal direction, and the free edge region may distort relative to the edge region where the snap-fit hook is provided, resulting for example in a non-parallel alignment of the gap around the profile element or chrome frame relative to the support element.

Accordingly, the invention sets out to solve the problem of mounting a profile element on a support element particularly of a motor vehicle radiator grille using means which are simple in construction, while obtaining very great accuracy in the fixing.

According to the invention this problem is solved by means of a profile element having the features of claim 1, a frame device having the features of claim 15, a support element having the features of claim 17 and a radiator grid arrangement having the features of claim 20. Advantageous features of the invention are the subject of the dependent claims.

The profile element according to the invention is intended for mounting on a support element, particularly of a radiator grille on a vehicle, and has a longitudinal configuration (or longitudinal extension). On an inner side of the profile element latching means are provided which are arranged in the region of an edge of the longitudinal extension and may be latched with latching means of the support element which are designed to complement them. The latching means on the profile element have a first portion which extends in a substantially cantilever arrangement away from the inside, and a second portion which extends substantially in the direction of the correspondingly opposite edge of the longitudinal extension.

If the profile element according to the invention is secured to a support element of a vehicle radiator grille, the longitudinal extension of the profile element may extend substantially in the direction of the transverse axis or width of the vehicle, and the first portion of the latching means of the profile element may extend substantially in the longitudinal direction of the vehicle, i.e. in the direction of the longitudinal axis of the vehicle. The first portion and second portion of the latching means of the profile element may enclose an angle of, in particular, 90° with one another.

Expediently, the profile element may further comprise, on an inner side thereof, and substantially at right angles thereto, at least one reinforcing rib which extends from the edge of the longitudinal extension in the region of which the latching means are provided, substantially in the direction of the opposite edge of the longitudinal extension.

The essential advantage of the profile element according to the invention is that thanks to the second portion of the latching means which extends from one edge of the longitudinal extension substantially in the direction of the correspondingly opposite edge of the longitudinal extension, and optionally also as a result of the reinforcing rib which extends on the inside of the profile element, again from one edge towards the opposite edge, the edge region of the longitudinal extension on which no latching means are provided is nevertheless held in a very precise position with respect to the support element. In other words, adverse torsion of the profile element in its longitudinal direction, i.e. pivoting or distortion of the edge region which is free from latching means, relative to the edge region on which the latching means are provided, is effectively prevented by the second portion of the latching means, optionally in conjunction with the reinforcing rib. This ensures that the gap runs precisely parallel relative to the support element, even for profile elements which are relatively tall, i.e. in a direction perpendicular to the longitudinal direction, even with latching means provided only along one edge, thereby making a major contribution to the improved appearance and quality appearance of the vehicle radiator grille.

According to an advantageous embodiment of the invention the profile element may preferably be made in one piece from a plastics material. As the standard radiator grilles for vehicles are generally chrome plated the plastics should be suitable for galvanic surface treatment, so that the plastics profile element can be wholly or partly covered with a chrome layer. The accurate fixing of the profile element to the support element as explained above has the advantage of hiding any distortion of the profile element caused during manufacture, due to the galvanic chrome plating of the surfaces, and at the same time connecting or latching the profile element sufficiently firmly to the support element. This ensures a secure and, as required, permanent connection between the profile element and the support element.

According to an advantageous further feature of the invention, a plurality of profile elements may be part of a so called frame device. Such a frame device thus comprises, for example, in a central area a number of these profile elements which are arranged, for example, parallel to one another. The injection moulding technology using thermoplastic materials, in particular, makes it readily possible to produce frame devices of this kind with a plurality of profile elements formed thereon.

The support element which serves to accommodate the profile element described above or the frame device with profile elements of this kind also has latching means designed to complement the latching means of the profile element. Expediently, the latching means of at least the support element are resiliently deformable. This ensures problem-free latching to the latching means of the profile element which has substantially rigid qualities, for example after chrome-plating.

The profile element according to the invention can also be secured to the support part with great positional accuracy even if it is relatively tall and the latching means are provided in only one edge region of the longitudinal extension. Thus, a significant saving in materials can be achieved for the profile element according to the invention, compared with another possible embodiment of a profile element in which latching means in the form of a snap-fit hook, for example, are provided in both the upper and lower edge regions of the longitudinal extension, thanks in particular to the construction of the latching means in only one edge region of the profile element. This advantageous saving in materials also applies to any subsequent chrome plating of the profile element.

Further advantages and features of the invention will become apparent from the description and the accompanying drawings.

It goes without saying that the features mentioned above and those to be described hereinafter may be used not only in the combination specified but in other combinations or on their own without departing from the scope of the present invention.

The invention is diagrammatically illustrated in the drawing by means of an exemplifying embodiment and is hereinafter described in detail with reference to the drawing.

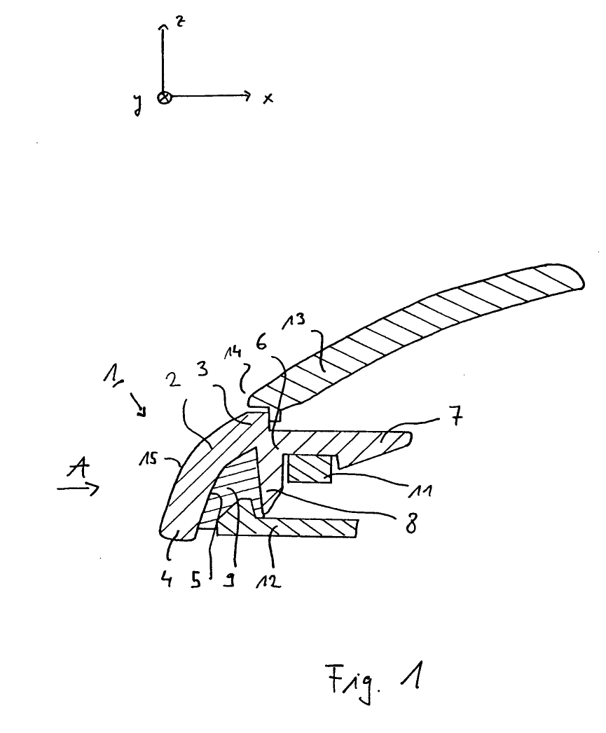

FIG. 1 shows a lateral sectional view of a profile element according to the invention mounted on a support element.

A profile element 1 according to the invention is shown in lateral section in FIG. 1. A main body 2 of the profile element is constructed in the shape of an L which is slightly curved over its height, i.e. in the z direction, and has an upper edge region 3 and a lower edge region 4. Adjacent to the upper edge region 3, latching means 6 are formed on an inner side 5 of the profile element 1. The latching means 6 have a first portion 7 and a second portion 8.

The profile element 1 is generally constructed with a longitudinal extension (or longitudinal dimension) extending in the y direction, although this is not shown in the sectional view in FIG. 1. When the profile element 1 is mounted on the radiator grille of a vehicle, said longitudinal extension may extend in the widthways direction of the vehicle. The latching means 6 may be formed at least partly along the longitudinal extent of the profile element 1. To save material it is expedient, for example, to provide the latching means 6 at several points along the longitudinal extent of the profile element 1, but only to a specified width (the y direction in FIG. 1). In other words, the profile element 1 has on its inside in the upper edge region 3 a plurality of individual latching means 6 formed thereon which comprise the first portion 7 and the second portion 8, as already explained. This plurality of individual latching means 6 on the one hand constitutes a beneficial saving in materials for the profile element 1 while at the same time ensuring accurate fixing of the profile element 1 to a support element 10 along the upper edge region 3.

The first portion 7 of the latching means 6 extends in cantilevered manner away from the inside 5 and in the embodiment shown here is constructed as a snap-fit hook with an undercut. The second portion 8 extends downwardly from the upper edge region 3, i.e. substantially in the direction of the lower edge region 4, thereby enclosing an angle of roughly 90° with the first portion 7. However, any other suitable angles may be enclosed between the first portion 7 and the second portion 8. Moreover, a reinforcing rib 9 is provided on each side of the latching means 6, respectively being formed substantially perpendicularly thereto on the inside 5 and extending from the upper edge region 3 towards the lower edge region 4.

The profile element 1 is intended for mounting on the support element 10 of a radiator grille (not shown) on a vehicle. The support element 10 in turn has latching means which complement the latching means 6 of the profile element 1. Specifically, these latching means are a latching strip 11 and a snap-fit hook 12.

When the profile element 1 is mounted on the support element 10, it is guided towards the support element 10, as shown in FIG. 1, in the direction indicated by the arrow A. The first portion 7 in the form of the snap-fit hook is latched to the latching strip 11 and at the same time the second portion 8 is latched to the snap-fit hook 12. The snap-fit hook 12 is constructed in width in the y direction in FIG. 1 such that it engages between two reinforcing ribs 9 formed on both sides of the latching means 6 on the inner side 5. The profile element 1 and the support element 10 are matched to one another so that in the latched position a rear edge of the upper edge region 3 of the profile element 1 is in contact with a lower edge of a support profile 13 of the support element 10. This produces a very precisely defined gap 14 in the outer region of the profile element 1 and support element 10, which gap extends in a precisely parallel fashion along the longitudinal extent of the profile element 1 (the y direction in FIG. 1).

The latching of the profile element 1 to the support element 10, inter alia, by means of the second portion 8 which cooperates with the snap-fit hook 12 of the support element 10, ensures, particularly in conjunction with the reinforcing rib or ribs 9 that the lower edge region 4 of the profile element 1 is secured with great positional accuracy with respect to the support element 10 even though there are no latching means, e.g. in the form of snap-fit hooks and the like, provided on the lower edge region 4. The effect of this is that a very precise gap size is maintained between the lower edge region 4 and adjacent other parts (not shown in FIG. 1) of the support element 10, thereby ensuring an excellent appearance and high quality standard of the vehicle radiator grille.

The above mentioned latching of the profile element 1 to the support element 10 by the latching means 6 has the additional advantage that any distortion of the profile element 1 contingently caused by the manufacturing process can readily be concealed by a coating, while the profile element 1 remains sufficiently firmly bonded to the support element 10. These two elements can be permanently clipped together by the above mentioned latching means of the profile element 1 and support element 10.

The profile element 1 may expediently be produced by injection moulding of a thermoplastic plastics material, in particular. This manufacturing process means that the possible shaping of the profile element 1 is very variable in every direction in space. In an advantageous embodiment a plurality of profile elements 1 are combined in a frame device, the frame device then being attached and clipped to the support element 10 as explained above.

In order to satisfy the need for a customary radiator grille finish with chrome surfaces, the plastics for the profile element are appropriately selected to be suitable for galvanic surface treatment. Thus, after injection moulding, the crude plastics part can be subjected to a galvanic surface treatment in the conventional manner, in which for example a chrome surface can be produced by applying a layer of nickel and a layer of copper, in that order. For simplicity sake the profile element 1 or the frame device with a plurality of profile elements is totally immersed in a suitable bath, in the course of the galvanic surface treatment, so that the profile element or frame device ends up totally chrome-plated. If the profile element has substantially rigid properties as a result of the chrome plating, the support element 10 is expediently made from a plastics, so that the latching strip 11 and the snap-fit hook 12 of the support element 10 have suitably resilient properties, thus ensuring latching to the latching means 6 of the profile element 1 when the latter is mounted in direction A on the support element 10. The plastics used for the support element 10 is suitably selected to provide a good basis for adhesion of a coat of enamel as support elements of this kind for radiator grilles are generally enameled.

After the end of the galvanic surface treatment at least an outer surface 15 of the profile element but preferably the entire surface thereof is coated with a mixed chrome layer.

The construction of the profile element 1 and of the support element 10 adapted thereto also have the advantage that the tool designs hitherto for this purpose do not have to be modified or require only slight modification. In connection with manufacture by injection moulding, a support tool in the form of an open and shut tool is suitable for the manufacture of the support element 10 while a tool design with suitable slide means so that for example the above mentioned snap-fit hooks can easily be removed from the mould is suitable for the profile element (1) or for a frame device comprising such profile elements.

The profile element 1 according to the invention gives rise to the advantage that the lower edge region 4 does not distort relative to the upper edge region 3 even when the profile element 1 is relatively tall (in the z direction shown in FIG. 1) and accordingly there is no undesirable torsion of the profile element 1 along its longitudinal dimension. Thus, in profile elements which are relatively tall, there is no need for additional latching means in the form of snap-fit hooks or the like, e.g. on the lower edge region 4, which leads to a major saving of material with regard to the plastics to be used and the subsequent chrome plating.

1. Profile element (1) for mounting on a support element (10), in particular on a vehicle radiator grille, said profile element having a longitudinal extension, with latching means (6, 7, 8) provided on an inner side (5) of the profile element (1), said latching means being arranged in the region of an edge (3) of the longitudinal extension and being adapted to latch to complementary latching means (11, 12) of the support element (10), the latching means (6) comprising a first portion (7) which extends in substantially cantilevered fashion away from the inside (5), and a second portion (8) which extends substantially in the direction of the correspondingly opposite edge (4) of the longitudinal extension.

2. Profile element (1) according to claim 1 which is fixed to a support element (10) of a radiator grille for a vehicle, the longitudinal extension of the profile element extending substantially in the direction of the transverse axis (y) of the vehicle and the first portion (7) of the latching means of the profile element (1) extending substantially in the direction of the longitudinal axis (x) of the vehicle.

3. Profile element (1) according to claim 2, wherein the first portion (7) and the second portion (8) together enclose an angle of, in particular, 90°.

4. Profile element (1) according to claim 3, wherein at least one reinforcing rib (9) is mounted on the inside (5), substantially perpendicular thereto, said rib extending from the edge (3) of the longitudinal extension in the region of which the latching means (6, 7, 8) are provided, substantially in the direction of the opposite edge (4) of the longitudinal extension.

5. Profile element (1) according to claim 4, wherein the reinforcing rib (9) is provided on each side of the latching means (6) in each case.

6. Profile element (1) according to claim 5, wherein the first portion (7) has an undercut and/or is constructed in the form of a snap-fit hook (7).

7. Profile element (1) according to claim 6, wherein the second portion (8) is constructed in the form of a strip and/or has an undercut.

8. Profile element (1) according to claim 7 which is manufactured in one piece.

9. Profile element (1) according to claim 8 which is made from a metallic material.

10. Profile element (1) according to claim 8 which is made from a plastics.

11. Profile element (1) according to claim 10 in which the plastics is a thermoplastic material.

12. Profile element (1) according to claim 10 wherein the plastics is suitable for galvanic surface treatment.

13. Profile element (1) according to claim 12 which has at least one chrome-plated outer side (15).

14. Profile element (1) according to claim 13 which is entirely chrome plated.

15. Frame device having at least one profile element (1) according to claim 14.

16. Frame device according to claim 15 which comprises a plurality of profile elements (1) which are arranged in particular parallel to one another.

17. Support element (10) for accommodating a profile element (1) according to one of claims 1 to 14 and/or a frame device according to claim 15 or 16, which comprises latching means (11, 12) complementing the latching means (7, 8) of the profile element (1), at least the latching means (11, 12) of the support element (10) being resiliently deformable.

18. Support element (10) according to claim 17, wherein a first portion (12) of the latching means has an undercut and cooperates with the second portion (8) of the latching means (6) of the profile element (1).

19. Support element (1) according to claim 18, wherein the first portion (12) of the latching means engages between the reinforcing ribs (9) provided on the inside (5) of the profile element (1).

20. Radiator grid arrangement on a motor vehicle, having a support element (10) according to claim 19, with a profile element (1) according to claim 14 and/or with a frame device according to claim 16.
